(19) United States
(12) Patent Application Publication
(10) Pub. No.: US 2026/0229375 A1
(43) Pub. Date: Aug. 6, 2026

(54) INTEGRAL BURNABLE COATING FOR RESISTING FUEL FRAGMENTATION, RELOCATION, AND DISPERSAL AND PELLET-CLADDING BOND FORMATION

(71) Applicant: Westinghouse Electric Company LLC, Cranberry Township, PA (US)

(72) Inventors: Edward J. Lahoda, Edgewood, PA (US); Kyle David Johnson, Nykoping (SE); Mattias Puide, Taby (SE)

(73) Assignee: Westinghouse Electric Company LLC, Cranberry Township, PA (US)

(21) Appl. No.: 19/044,727

(22) Filed: Feb. 4, 2025

(51) Int. Cl. G21C 3/04; G21C 3/20; G21C 3/60; G21C 3/62

(52) U.S. Cl. CPC G21C 3/047; G21C 3/20; G21C 3/60; G21C 3/623

(57) ABSTRACT

A nuclear fuel rod with high burnup suppression includes a cladding; a plurality of fuel pellets arranged inside the cladding, each pellet comprising fissile material; and a first layer including a burnable absorber disposed on at least one of an outer surface of the fuel pellets, an inner surface of the cladding, or an outer surface of the cladding, the burnable absorber disposed on the pellet burning out after about 20 MWd/kgU or more of fuel burnup, the burnable absorber disposed on the cladding burning out after about 15 MWd/kgU or more of fuel burnup.

### TECHNICAL FIELD

The present disclosure relates generally to a system and method for resisting ballooning and bursting of nuclear fuel rod cladding and the associated nuclear fuel fragmentation, relocation, and dispersal. The present disclosure further relates to a system and method for resisting bond formation between nuclear fuel pellets and cladding. The present disclosure further relates to a system and method for suppressing the formation of the high burnup structure (HBS). More particularly, this disclosure is directed to a system and method of coating various fuel rod surfaces.

### BACKGROUND

In a nuclear reactor such as a pressurized water reactor (PWR) or a boiling water reactor (BWR), the reactor core includes a large number of fuel assemblies, each of which is composed of a plurality of elongated fuel elements or rods. The fuel rods each contain fissile material such as uranium dioxide (UO₂) or plutonium dioxide (PuO₂), or mixtures of these, usually in the form of a stack of nuclear fuel pellets, although annular or particle forms of fuel also are used. The fuel rods are grouped together in an array which is organized to provide a neutron flux in the core sufficient to support a high rate of nuclear fission and thus the release of a large amount of energy in the form of heat. A coolant, such as water, is pumped through the core to extract some of the heat generated in the core for the production of useful work. Fuel assemblies vary in size and design depending on the desired size of the core and the size of the reactor.

During the initial operation of the reactor core, a fissile material may produce an excess number of neutrons during this stage of the fission reaction. The reactivity of the fissile material declines after the initial operation and can result in variable reactivity over the lifetime of the reactor. A more desirable result may be a constant reactivity over the lifetime of the reactor. Various methods may be used to counteract or absorb the initial excess reactivity of the fissile material. Typically, control rods are inserted into the reactor cores to absorb the excess neutrons. Additionally, the fuel composition may be tailored for constant reactivity or to attain certain burnup levels. The control rods and fuel compositions use a neutron absorber, known in the art as “burnable poisons” or “burnable absorbers”, and may include boron, gadolinium, cadmium, samarium, erbium and/or europium compounds.

Burnable absorbers absorb the initial excess neutrons while, ideally, producing no new or additional neutrons or changing into new neutron absorbers as a result of neutron absorption. During the early stages of operation of such a fuel element, excess neutrons are absorbed by the burnable absorber, which preferably undergoes transformation to elements having a low number of neutrons. The fuel pellets may be coated in a thin external layer of zirconium diboride (ZrB₂) or a similar material creating an integral fuel burnable absorber (IFBA).

However, the boron in a ZrB₂ IFBA coated fuel pellets produces helium gas as a byproduct of their neutron absorption, through a (n,α) reaction. The production of gas within the fuel rod can be problematic because the fuel rod is a sealed housing. Thus, the production of gas increases the internal pressure of the fuel rod (known as rod internal pressure, or RIP). The fission reaction itself produces gases that contribute to the increase of the internal pressure of the fuel rod (known as fission gas release, or FGR). The internal pressure of the fuel rod must stay under certain levels so that the pressure does not compromise the structural integrity of the fuel rod. This creates a tradeoff between safe operating the fuel rod internal pressure, higher burnup fuel compositions, and IFBA materials to absorb excess neutrons. Therefore, the internal pressure of the fuel rod acts as a limiting factor against increasing fuel burnup level, extending fuel lifetime, or maintaining constant reactivity.

The formation of a high-burnup rim structure on the fuel pellets can lead to deleterious effects on fuel performance. One deleterious effect is degradation of rim thermal conductivity, which is associated with an increase in peak centerline temperatures (PCT) of the fuel pellet. This degradation can limit the linear power and rating the fuel can experience and can result in increased FGR and RIP.

Further, the formation of a high-burnup (HBU) rim structure (HBS) at the rim of a fuel pellet can degrade the rim mechanical integrity. Degradation of the rim mechanical integrity is associated with enhanced fuel fragmentation during loss of coolant accidents (LOCA).

This high-burnup rim structure is caused by two factors. One factor is low temperatures of the rim, which prevents elimination of irradiation-induced matrix defects. The second factor is the soft (or slow, thermal) neutron spectrum associated with the rim, being directly adjacent to the neutron moderator. This results in locally enhanced fission rates, enhanced transmutation of uranium-238 (²³⁸U) to plutonium-239 (²³⁹Pu), and the buildup of high concentrations of the latter and fission products (owing to locally high fission rates and high concentrations of ²³⁹Pu) during residence in the nuclear reactor.

### SUMMARY

In a first embodiment, the present disclosure describes a nuclear fuel rod with high burnup suppression. The rod includes: a cladding; a plurality of fuel pellets arranged inside the cladding, each pellet comprising fissile material; and a first layer including a burnable absorber disposed on at least one of an outer surface of the fuel pellets, an inner surface of the cladding, or an outer surface of the cladding, the burnable absorber disposed on the pellet burning out after about 20 MWd/kgU or more of fuel burnup, the burnable absorber disposed on the cladding burning out after about 15 MWd/kgU or more of fuel burnup.

In one aspect of the first embodiment, the first layer is to suppress formation of a high-burnup rim structure by at least 10 MWd/kgU of fuel burnup.

In another aspect of the first embodiment, which may be combined with one or more previously recited aspects of the first embodiment, formation of a high-burnup rim structure is suppressed until at least 50 MWd/kgU of fuel burnup.

In another aspect of the first embodiment, which may be combined with one or more previously recited aspects of the first embodiment, the burnable absorber includes at least one of boron, gadolinium, europium, dysprosium, samarium, cadmium, iridium, hafnium, ytterbium, erbium, or an oxide, nitride, carbide, or boride thereof.

In another aspect of the first embodiment, which may be combined with one or more previously recited aspects of the first embodiment, the first layer is coating the outer surface of a plurality of the pellets.

In another aspect of the first embodiment, which may be combined with one or more previously recited aspects of the first embodiment, no second layer that includes fissile material exists between the first layer and the fissile material.

In another aspect of the first embodiment, which may be combined with one or more previously recited aspects of the first embodiment, no second layer exists between the first layer and the fissile material.

In another aspect of the first embodiment, which may be combined with one or more previously recited aspects of the first embodiment, the fissile material includes at least one of uranium-233 dioxide, uranium-235 dioxide, plutonium-239 dioxide, mixed oxide (MOX), or nitrides, carbides, borides, or metals of the same. The fissile material may include one or more additives, some of which are chromium oxide (Cr₂O₃), aluminum oxide (Al₂O₃), silicon dioxide (SiO₂), and the like. Concentrations of the additives may be up to 3000 parts per million (ppm) or more.

In another aspect of the first embodiment, which may be combined with one or more previously recited aspects of the first embodiment, the first layer prevents a chemical bond between the cladding and the fuel pellet.

In another aspect of the first embodiment, which may be combined with one or more previously recited aspects of the first embodiment, the first layer of material coats the inner surface of the cladding.

In another aspect of the first embodiment, which may be combined with one or more previously recited aspects of the first embodiment, a composition of and a radial thickness of the first layer reduces a rim peak-to-average radial chemical profile of each fuel pellet to below a determined threshold at a determined burnup.

In another aspect of the first embodiment, which may be combined with one or more previously recited aspects of the first embodiment, each fuel pellet comprises uranium dioxide and a total thermal neutron interaction cross section of the burnable absorber exceeds a U-238 thermal neutron capture cross section.

In another aspect of the first embodiment, which may be combined with one or more previously recited aspects of the first embodiment, the first layer comprises one or more chemical compounds that after undergoing neutron-induced transformation into a new species, element, or compound, or undergoing a chemical reaction or otherwise decomposing inhibit formation of a bond between the uranium dioxide and the cladding.

In another aspect of the first embodiment, which may be combined with one or more previously recited aspects of the first embodiment, the one or more chemical compounds includes at least one of B, ZrB₂, HfB₂, SmB₄, or SmB₆.

In another aspect of the first embodiment, which may be combined with one or more previously recited aspects of the first embodiment, a concentration of the burnable absorber in the first layer and/or a thickness of the first layer suppresses a difference between a concentration of a fission product at a radial edge of the fissile material and a concentration of the fission product at a center of the fissile material to a determined level at a determined burnup.

In another aspect of the first embodiment, which may be combined with one or more previously recited aspects of the first embodiment, the fission product is at least one of cerium, neodymium, cesium, xenon, krypton oxygen, zirconium, molybdenum, or ruthenium.

In another aspect of the first embodiment, which may be combined with one or more previously recited aspects of the first embodiment, the first layer is boron-free.

In a second embodiment, the present disclosure describes a coating on a surface of a fuel rod. The coating includes a burnable absorber that burns out after about 20 MWd/kgU or more of fuel burnup.

In a third embodiment, the present disclosure describes a method for suppression of high burnup. The method includes: applying a coating to a surface of a fuel rod, wherein the coating comprises at least one of boron, gadolinium, europium, dysprosium, samarium, cadmium, iridium, hafnium, ytterbium, erbium, or an oxide, nitride, carbide, or boride thereof; and suppressing, by the coating, formation of a high-burnup rim structure in the fuel rod until at least 50 MWd/kgU of fuel burnup.

In another aspect of the third embodiment, applying the coating comprises at least one of three-dimensional (3D) printing, composite manufacturing, plasma deposition, dipping, painting, high temperature hot spray, cold spray, chemical vapor deposition, physical vapor deposition, or ion implantation.

In a fourth embodiment, the present disclosure describes a method for reducing cladding-fuel bonding. The method includes: applying a coating to an outer surface of a fuel pellet comprising uranium dioxide or an inner surface of cladding, wherein the coating includes at least one or more chemical compounds that after undergoing neutron-induced transformation into a new species, element, or compound, or undergoing a chemical reaction or otherwise decomposing inhibit formation of a bond between the uranium dioxide and the cladding.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The apparatuses, systems, and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 shows a cross-sectional view along the axis of a fuel rod.

FIG. 2 shows a cross-sectional view perpendicular to the axis of a fuel rod.

FIGS. 3A-3C present photographs of burst fuel rods from LOCA tests.

FIG. 4 depicts fine fragmentation of nuclear fuel as a function of temperature and pressure in a fuel rod.

FIGS. 5A and 5B present photographs of a shake test on fuel rods containing non-IFBA coated fuel pellets and IFBA-coated fuel pellets, respectively.

FIGS. 6A-6C present bar graphs of fission gas release.

FIG. 7A presents a photograph of a cross-sectional cut of a fuel rod with IFBA-coated fuel pellets in accordance with some embodiments of the present disclosure.

FIG. 7B is an enlargement of a portion of FIG. 7A in accordance with some embodiments of the present disclosure.

FIGS. 8A and 8B present photographs of fuel-cladding interface of a non-IFBA fuel rod.

FIGS. 9A and 9B present cross sections of non-IFBA fuel rod in accordance with an aspect of the present disclosure.

FIG. 10 presents a photograph of a cross-sectional cut of an IFBA fuel rod in accordance with some embodiments of the present disclosure.

FIGS. 11A and 11B present photographs of IFBA and non-IFBA fuel rods, respectively, in accordance with some embodiments of the present disclosure.

FIGS. 12A-12C depict a series of plots that demonstrate effects of an HBS on the properties of a fuel pellet without IFBA coating.

FIG. 13 presents a flattened distribution of element concentration as a function of radial distance in accordance with some embodiments of the present disclosure.

FIGS. 14A-14E present chemical analysis data of IFBA fuel rod in accordance with some embodiments of the present disclosure.

FIGS. 15A and 15B present IFBA fuel rod chemical concentration as a function of radial distance in accordance with some embodiments of the present disclosure.

FIGS. 16A and 16B present ADOPT™ fuel rod chemical concentration as a function of radial distance.

FIG. 17 presents standard UO₂ fuel rod chemical concentration as a function of radial distance.

FIGS. 18A and 18B present rim peaking factor and rim thickness, respectively, as a function of local burnup in accordance with some embodiments of the present disclosure.

### DETAILED DESCRIPTION

One or more aspects of the present disclosure addresses the high-burnup rim structure caused by the transmutation of ²³⁸U to ²³⁹Pu and the buildup of high concentrations of the latter and fission products of the latter during residence in the nuclear reactor.

One or more aspects of the present disclosure relate to a nuclear fuel resistant to high-burnup rim structure formation and suppressed fuel-clad bonding using either a fuel surface coated or cladding inner or outer coated burnable absorber, which can include any of boron (B), gadolinium (Gd), europium (Eu), dysprosium (Dy), samarium (Sm), cadmium (Cd), iridium (Ir), hafnium (Hf), or oxides, nitrides, carbides, or borides thereof or other suitable material. The concentration of the burnable absorber may be adjusted to ensure assembly-level reactivity up to a design basis End of Life.

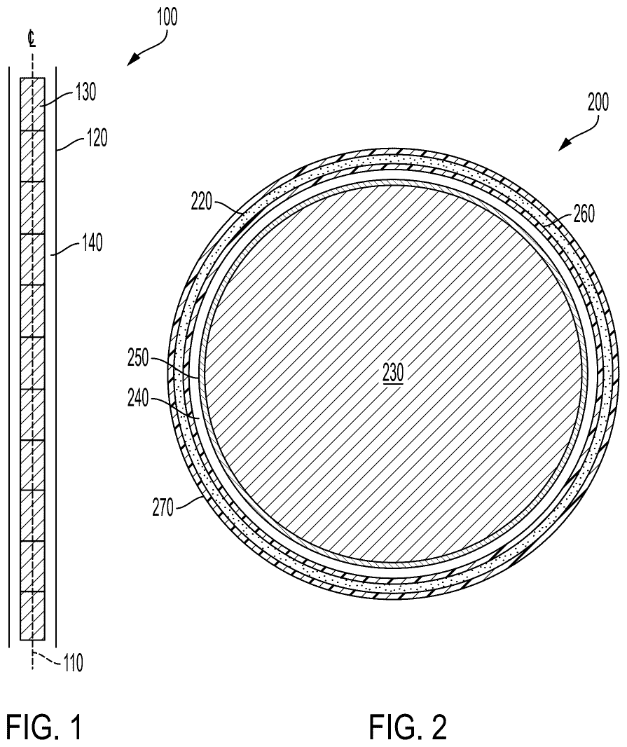

Referring to FIG. 1, a cross-sectional view along the axis 110 of a fuel rod 100 is presented. The fuel rod 100 includes cladding 120 that forms a tube. The cladding 120 may be in the form of a cylindrical tube or a non-cylindrical tube. Examples of non-cylindrical tubes include tubes with cross sections that are oval, elliptical, regular polygonal (e.g., square, rectangular, pentagon, hexagon, and the like), irregular polygons, and combinations of the aforementioned. The cladding 120 may comprise zirconium, such as a zirconium alloy, although other suitable materials may be used. The cladding 120 isolates the coolant located outside the cladding 120 from the nuclear fuel pellets 130 inside the cladding 120. The pellets include a fissile material such as uranium dioxide (UO₂). The uranium may be enriched with uranium-235.

In this disclosure, reference to fuel pellets 130, or pellets, does not designate a particular shape or dimension to the pellet unless otherwise specified. A pellet may be a small rounded, spherical, or cylindrical body, but a pellet may have any arbitrary shape, regular or irregular, or size suitable for containment in cladding 120. Fuel pellets 130 may be stacked in the axial direction 110 of the fuel rod 100.

Fresh fuel is fabricated with a gap 140 between the cladding 120 and the fuel pellets 130. This gap 140 may be filled with a gas such as helium during the manufacturing process, although other gases may be used as appropriate.

FIG. 2 depicts a cross-sectional view perpendicular to the axis 110 of a fuel rod 200. The fuel rod 200 includes a fuel pellet 230 contained within cladding 220. A gap 240 exists between the cladding 220 and the fuel pellet 230. In one or more embodiments, the fuel pellets 230 may be coated with an integral fuel burnable absorber (IFBA) 250. An IFBA coating 260 may be applied on the inner surface of the cladding 220. In one or more embodiments, an IFBA coating 270 may be applied to the outer surface of the cladding 220. In one or more embodiments, only one IFBA coating 250, 260, 270 may be applied. In other embodiments, any combination of two or three IFBA coatings 250, 260, 270 may be applied. The IFBA coatings 250, 260, 270 may be applied in any suitable manner including plasma deposition, dipping, painting, high temperature hot spray, cold spray, chemical vapor deposition, physical vapor deposition, duplex coating, electrolytic or electrodeposition, and ion implantation or sputtering, three-dimensional (3D) printing and composite manufacturing methods, and variations thereof. Applicable composite manufacturing methods include wet layup (hand layup), spray up, compression molding, injection molding, resin transfer molding, high pressure resin transfer molding, vacuum infusion, filament winding, open molding, and closed molding. The IFBA may include zirconium boride (ZrB₂) and/or other suitable materials that ideally have a large cross section for absorbing thermal neutrons, but which are consumed (or burned up) in the process (reaction) and converted into a material with a smaller thermal neutron cross section though other compounds such as Gd₂O₃ are still used even though they maintain a high thermal neutron cross-section after absorbing a neutron. Other suitable materials for an IFBA may include gadolinium (Gd), europium (Eu), dysprosium (Dy), samarium (Sm), cadmium (Cd), iridium (Ir), hafnium (Hf), or oxides, nitrides, carbides, or borides of these elements.

When a nuclear reactor experiences a loss of coolant accident (LOCA), the concomitant loss of the ability to cool increases the temperature in the fuel rods and high temperature creep such that the fuel rods (specifically the cladding 120) may balloon and burst, and nuclear fuel fragmentation, relocation, and dispersal (FFRD) may occur. During a LOCA, coolant is lost and the temperature of the core increases, including the temperature of individual fuel rods. A fuel rod contains gas, helium, xenon, krypton and iodine, for example, that occupies any volume inside the rod that is not occupied by the fuel pellets.

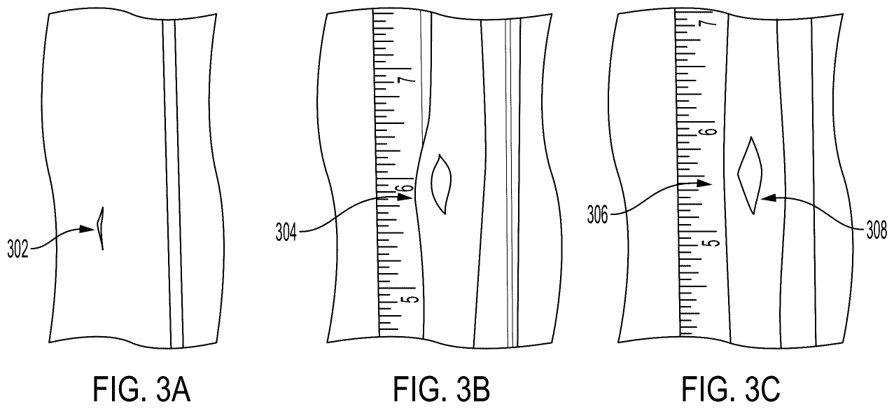

During LOCA testing at Studsvik in Sweden, it was observed that fuel rods that contained fuel pellets coated with a layer of integral fuel burnable absorbers (IFBA) produced small burst openings and negligible fuel loss and fragmentation. FIGS. 3A-3C showing the ballooning and bursting of three fuel rods from the Studsvik LOCA testing. FIG. 3A is a photograph of a fuel rod identified by Test ID 196 in Tables 1 and 2 below. The fuel pellets in sample 196 are coated with IFBA. The photograph, taken so close to the fuel rod that the edges of the fuel rod are not visible, shows little ballooning of the cladding and a burst 302 that appears to be essentially closed. FIG. 3B is a photograph of Limerick fuel test segment ICL #3, which was subjected to LOCA testing at Oak Ridge National Laboratory (ORNL). This fuel rod shows significant ballooning and bursting 304. The fissile fuel (fuel pellets) are not visible in the photograph and appear to have been lost to the environment around the cladding of this fuel rod. The lack of visible fuel pellets indicates likely fuel fragmentation, redistribution, and dispersal (FFRD). FIG. 3C is a photograph of Limerick test segment ICL #4. Similar to FIG. 3B, the fuel rod in FIG. 3C shows significant ballooning and bursting 306. The burnup for each of the fuel rods is 60 MWd/kgU (local) for IFBA-coated M14, 66 MWd/kgU (local) for ICL #3, and 67 MWd/kgU (local) for ICL #4. The burnup varies along the axis of the fuel rod peaking approximately in the middle to upper third of the rod. The burnup at any one point is termed the local burnup while the burnup averaged over the whole rod is termed the rod average burnup.

Table 1 below presents the test results for six fuel rods. The burnup indicates the amount of energy produced in megawatt-days (MWd) for each mass of fuel, expressed in kilograms of uranium (kgU). The hydrogen level is an indicator of zirconium cladding reacting with water to liberate hydrogen gas, some portion of which has partially diffused into the cladding to form zirconium hydrides. Thus, higher levels of hydrogen as zirconium hydride (expressed in parts per million (ppm)) are indicative of greater corrosion of the zirconium cladding. A related measurement is the equivalent cladding reacted (ECR), expressed in percent. ECR is an indicator of how much of the zirconium cladding has reacted with water to form hydrogen, some of which can migrate into the cladding to form hydrides.

Still referring to Table 1, the burst pressure in bars, the burst temperature in degrees Celsius (° C.), and the burst strain in percent indicates those respective measurements at the point the cladding burst open during the LOCA testing. The rupture opening expresses the length by the maximum width of the rupture. The two samples that included an IFBA coating, test IDs 196 and 198, had the smallest openings.

TABLE 1
Studsvik LOCA test

| | Burnup | | | | | | |
|---|---|---|---|---|---|---|---|
| | (parent | Cladding | | | | | |
| | rod | Hydride | Burst | Burst | Burst | Rupture | |
| Test | average | level | pressure | temp | strain | opening | ECR |
| ID | MWd/kgU | ppm | bar | ° C. | % | mm | % |
| 189 | 71 | 176 | 113 | 700 | 48 | 24 × 10 | 0 |
| 191 | 71 | 271 | 104 | 680 | 50 | 22 × 17 | 13 |
| 192 | 71 | 288 | 77 | 700 | 56 | 23 × 9 | 11 |
| 193 | 71 | 187 | 77 | 728 | 51 | 18 × 14 | 17 |
| 196 | 55 | 149 | 72 | 686 | 25 | 1.5 × 0.2 | 0 |
| 198 | 55 | <149 | 74 | 693 | 25 | 1.6 × 11 | 15 |

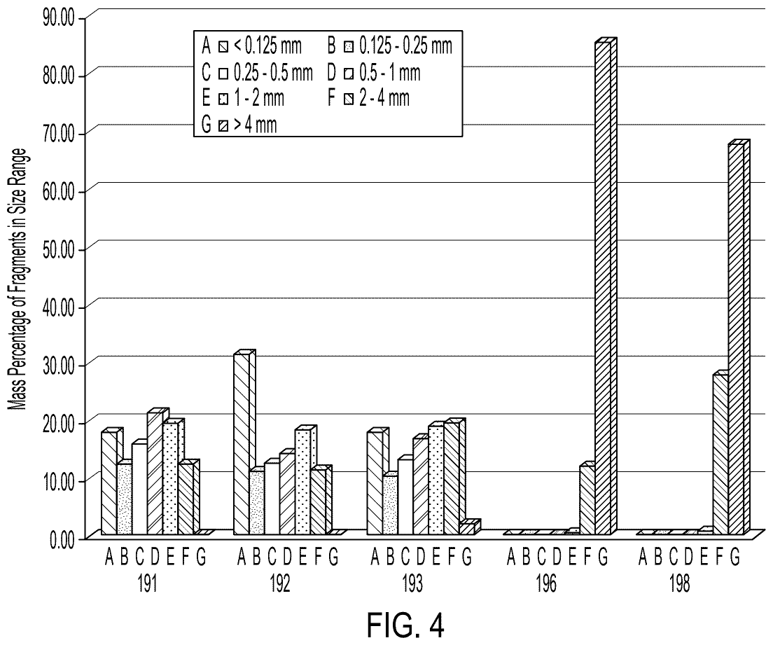

FIG. 4 presents a bar graph showing the fuel pellet fragment size distribution for each test. Bar A represents fragments less than 0.125 millimeters (mm) in size. Bar B includes the range from 0.125 to 0.25 mm; bar C from 0.25 to 0.5 mm; bar D from 0.5 to 1.0 mm; bar E from 1 to 2 mm, bar F from 2 to 4 mm, and bar G greater than 4 mm. Visually and statistically, the fuel pellet fragment size distributions fall into two categories. The first, including tests 191, 192, and 193, are largely made of small fragments of fissile material that are more easily passed through an opening in cladding. These three tests had fuel pellets that were not coated with IFBA. The second category, tests 196 and 198, had essentially only very large and large fragments of fuel pellets, that pellets less likely to be able to escape a fuel rod cladding that had burst during LOCA. The fuel pellets in tests 196 and 198 were coated with IFBA.

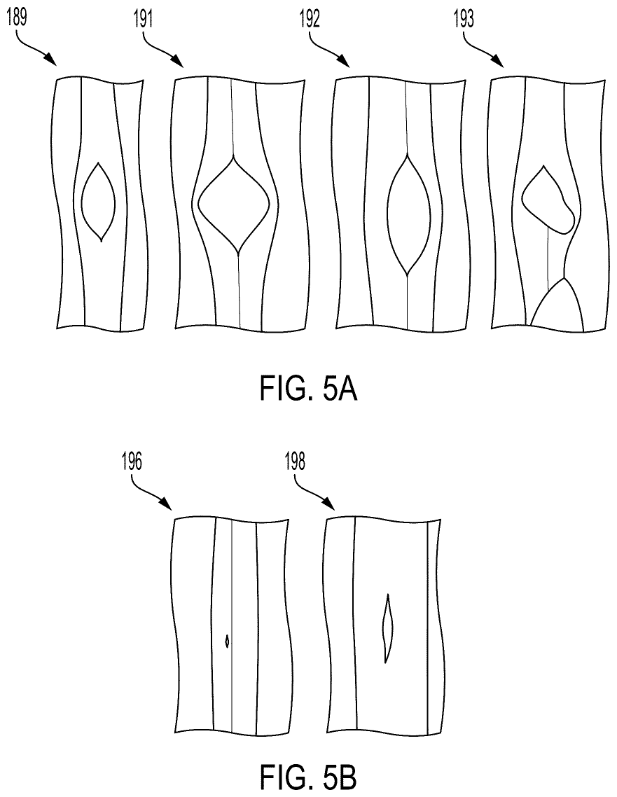

FIGS. 5A and 5B present photographs of the ruptured cladding for each sample following a shake test. FIG. 5A shows the non-IFBA samples, while FIG. 5B shows the two IFBA-coated samples. Visually, one again notes two clear categories. Tests 189, 191, 192, and 193 using non-IFBA coated fuel pellets, shown in FIG. 5A, have their respective claddings burst wide open, and show an absence of fuel pellets in the rupture plane of the fuel rods. In contrast, tests 196 and 198 that used IFBA-coated pellets have significantly smaller burst openings, a benign response to their respective LOCA tests. Note that the 198 rod picture seems to be a bigger enlargement compared to the others (assuming the unballooned rod diameters are about the same).

Table 2 below presents a summary of the shake test characteristics and results for fuel-rod averages for each of the six samples shown in FIGS. 5A and 5B. In the comments for each test, PCT refers to the peak centerline temperature of the fuel pellet at the centerline 110. The cladding was the same for each test, ZIRLOT, an advanced zirconium-based alloy that has high corrosion resistance to reactor coolant, fuel, and fission products.

As shown in Table 2, the fuel mass lost during LOCA was >41, 52, 68, 105, 0, and 0 grams (g) for Test Identification (ID) 189, 191, 192, 193, 196, and 198, respectively. In other words, neither test where the fuel pellets had an IFBA coating lost any fuel mass.

The samples with an IFBA coating performed markedly better than fuels that lack this coating at medium burnup (58-60 MWd/kgU) at FFRD threshold. The IFBA-coated fuels had no significant fuel loss, fragmentation, or ballooning/bursting.

TABLE 2
Summary of Fuel Loss during LOCA Test Characteristics and Results

| Test ID | 189 | 191 | 192 | 193 | 196 | 198 |
|---|---|---|---|---|---|---|
| Rod ID | AM2-E08- | AM2-F10- | AM2-E08- | AM2-F10- | M14-L3 | M14-L2 |
| | 2-1 | 2-2 | 2-2 | 2-1 | | |
| Comments | Ramp to | Ramp to | Ramp to | Ramp to | Ramp to | Ramp to |
| | rupture | PCT, held | PCT, held | PCT, held | rupture test | PCT, held |
| | test | for 25 s at | for 5 s at | for 85 s at | | for 85 s at |
| | | PCT | PCT | PCT | | PCT |
| Cladding | ZIRLO | ZIRLO | ZIRLO | ZIRLO | ZIRLO | ZIRLO |
| Rod Type | UO₂ | UO₂ | UO₂ | UO₂ | IFBA-ZrB₂ | IFBA-ZrB₂ |
| | | | | | coating | coating |
| Burnup | ≈72 | ≈71 | ≈72 | ≈71 | ≈55 | ≈55 |
| (rod average) | | | | | | |
| (GWd/MTU) | | | | | | |
| Fuel Mass | >41 | 52 | 68 | 105 | 0 | 0 |
| Released | | | | | | |
| During LOCA | | | | | | |
| (g) | | | | | | |

Fission gas release is a process that leads to deleterious effects on fuel pellets, the cladding, and the fuel-cladding gap. During fission of ²³⁵U or ²³⁹Pu, fission gas is generated. The two most abundant fission gases in this process are krypton (Kr) and xenon (Xe). The gases may migrate through the fuel and cluster along grain-grain interfaces in the fuel pellets as well as migrate to the surface of the pellets. The effects include formation of cracks in the fuel pellets that may contribute to fuel pellet fragmentation, particularly during ballooning and bursting of the cladding. In addition, expansion of the fuel pellet may shrink and even eliminate the gap between the cladding and the fuel pellet.

Table 3 below provides information regarding six fuel rods used in a fission gas release test. The six fuel rods were in the same fuel rod assembly, assembly U26, with positions as recorded. The cladding alloy for VCS1 and VCS 2 was Optimized ZIRLO™. The fuel pellet used in VCS1 is an IFBA coated ammonium diuranate (ADU) pellet. The fuel pellets in the remaining samples are ammonium diuranate (ADU) pellets. ADU, integrated dry route powder process (IDR), and ammonium uranyl carbonate (AUC) are three means of providing uranium dioxide for fuel. The burnup of the samples was approximately the same.

TABLE 3
Fission Gas Release, Results

| Rod Alias | VCS1 | VCS2 | VCS3 | VCS4 | VCS5 | VCS6 |
|---|---|---|---|---|---|---|
| Assembly | M4 | K4 | D1 | Q4 | N1 | A4 |
| Position | | | | | | |
| Alloy | Westinghouse | Westinghouse | Westinghouse | Westinghouse | Westinghouse | Westinghouse |
| | Zirconium | Zirconium | Advanced | Advanced | Advanced | Advanced |
| | Alloy | Alloy | Zirconium | Zirconium | Zirconium | Zirconium |
| | | | Alloy | Alloy | Alloy | Alloy |
| Pellet Type | IFBA | ADU | ADU | ADU | ADU | ADU |
| Burnup | 73.36 | 71.03 | 70.23 | 70.12 | 70.4 | 69.79 |
| (MWd/kgU) | | | | | | |

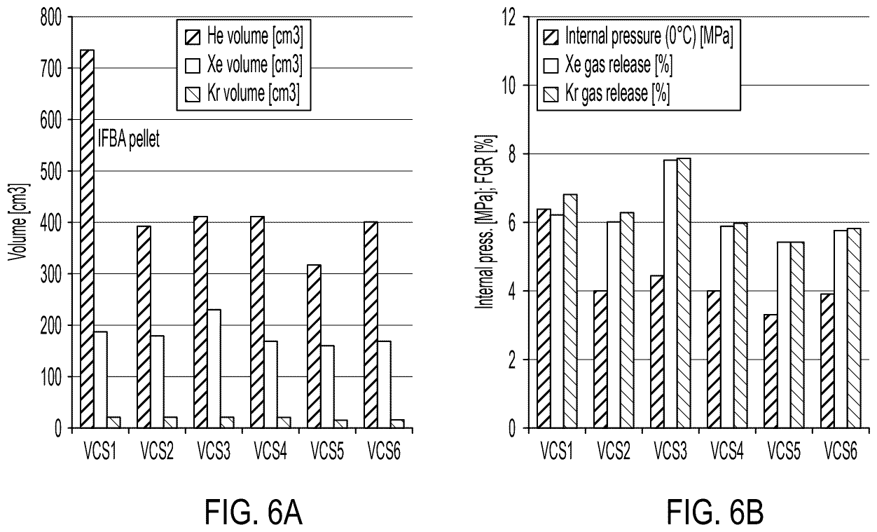

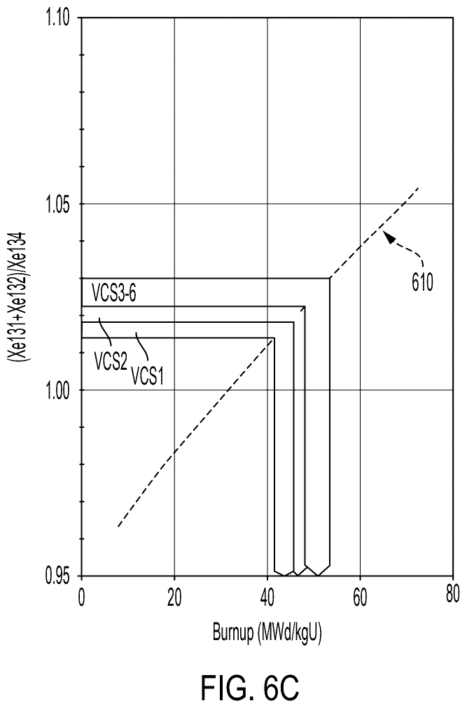

Referring to FIG. 6A, the volume in cubic centimeters (cm³) of three fission gases for each fuel rod tested during the fission gas release test. From left to right for each fuel rod, the gases are helium (He), xenon (Xe), and krypton (Kr). Fuel rod VCS1, the only sample with fuel pellets coated with IFBA, produced about twice as much helium as the other samples. This is to be expected as the zirconium boride produces He, whose boron nucleus, after capturing a thermal neutron, decays into lithium and an alpha particle. The alpha particle is the nucleus of a helium atom. The other samples, lacking the IFBA coating, produce less helium. The volumes of Xe and Kr produced are relatively equal across all samples.

FIG. 6B present internal pressure data, in megapascals (MPa), and fission gas release in percent for the six samples tested in the fission gas release test. For each sample, bars are presented for internal pressure at 0° C., xenon gas release, and krypton gas release, from left to right. There is some variation across the samples, including a higher internal pressure in sample VCS1, due to the greater volume of helium released by that sample from the zirconium diboride.

Referring now to FIG. 6C, for each of the six samples evaluated in the fission gas release test, the ratio of the sum of xenon-131 plus xenon-132 to xenon-134 as a function of burnup, where the number of atoms per volume are summed, being proportional to pressure under the ideal gas law. The fission yield of Xe131 and Xe 132 increases with burnup, while the fission yield of Xe134 decreases, due to different yields in uranium fission and plutonium fission. As the fuel pellet material reacts with neutrons, some uranium is transmuted into plutonium. Thus, over time fewer undecayed uranium nuclei produce less Xe131 and Xe132 while the increasing presence of plutonium nuclei increases the fission yield of Xe134. As a result, the plotted ratio increases with time and burnup.

Samples VCS3-VCS6 602 have a ratio of about 1.03, released at a burnup of about 50 MWd/kgU. VCS2 604 with ADU pellets (rod internal pressure) and VCS1 608 with IFBA-coated pellets (rod internal pressure) show what appears to be a fission gas release 5-8 MWd/kgU “earlier,” i.e. a greater proportion of fission gas derives from ²³⁵U fission rather than ²³⁹Pu fission. than VCS3-VCS6 602. Internal rod pressure measurements may be performed using a calibrated gas and volume measurements system that uses a series of pressure gauges and known expansion volumes from which the rod internal volume and pressure may then be calculated. These measured ratios are compared to calculated ratios 610.

One explanation for the VCS1 and VCS2 “earlier” fission gas release may attribute the difference to fuel rod position in the assembly, pellet type, temperature and power history. Another explanation, pointing to an unexpected and surprising result, has to do with the differences between IFBA-coated fuel pellets and non-IFBA-coated fuel pellets. As seen in FIGS. 6A and 6B, both IFBA and non-IFBA fuel pellets have similar fission gas release. The one exception is the much higher production of helium with IFBA due to the reaction ¹⁰B+n→⁷Li+α, where n is a neutron and a is an alpha particle. The presence of the IFBA coating makes a significant shift in fission gas produced in uranium fission as opposed to fission gas produced in plutonium fission when compared to non-IFBA samples. The shift gives the appearance of a shift in time when in fact it is due to the suppression of the formation of plutonium at the rim of the fuel pellet until after the IFBA is depleted.

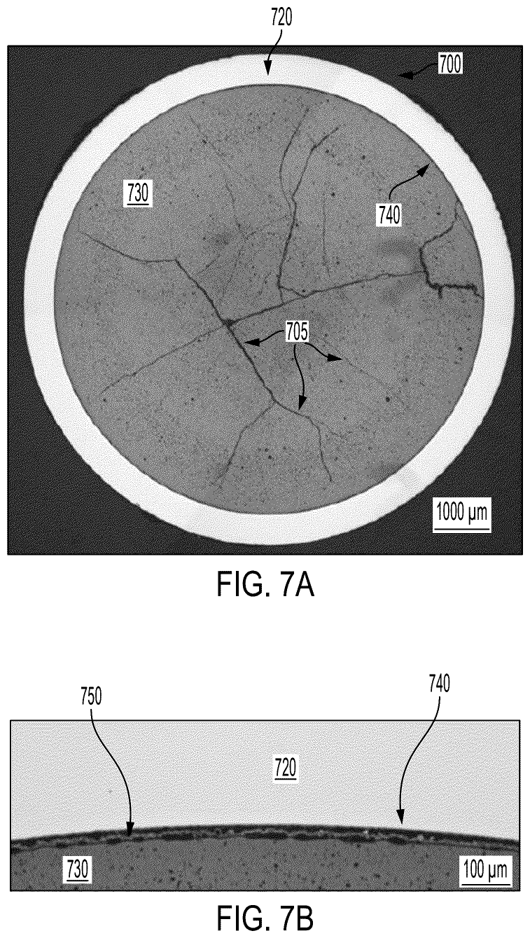

Referring now to FIGS. 7A-11B, differences between IFBA-coated and non-IFBA coated fuel pellets in cladding will be examined photographically. FIG. 7A is a photograph of a cross-sectional cut of previously discussed fuel rod VCS1 700. The fuel pellet 730 is inside the cladding 720 with a gap 740 between the two. Cracks 705 of various lengths and widths are clearly visible. The white bar in the lower right of the figure represents 1000 micrometers (μm), or 1 mm. This slice was taken at approximately 2000 mm from the bottom of the rod, or approximately the midline of the 4 m rod. FIG. 7B presents an enlarged portion of FIG. 7A that details the gap 740 between the cladding 720 and the fuel pellet 730. The gap 740 exists and is open. The IFBA coating layer is also visible. Further, the edge of the fuel pellet 730 appears the same as the rest of the fuel pellet 730. In other words, a high burnup (HBU) rim is not visible and seems not to be present, likely as a result of the IFBA coating 750, which appears gray and immediately inside the gap 740. The white bar in the lower right of the figure represents 100 μm.

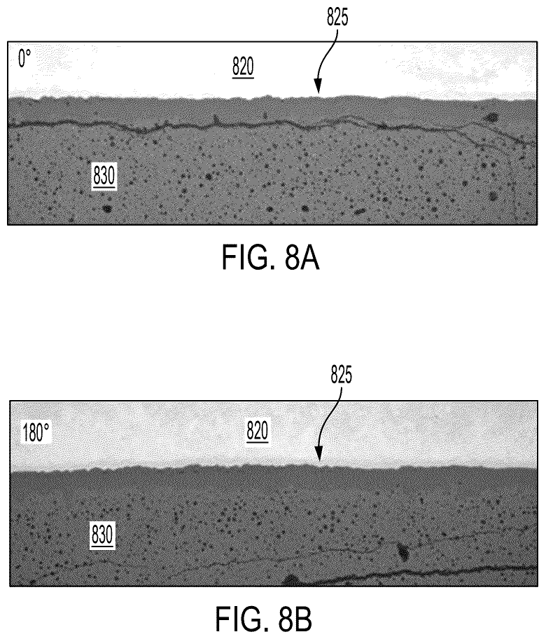

In contrast, FIGS. 8A and 8B present photographs, taken at diametrically opposite sides (0° and 180°, respectively) of previously discussed non-IFBA-coated fuel rod VCS2. FIGS. 8A and 8B show the cladding 820 and the fuel pellet 830. Notable is the lack of a gap between these two parts of the fuel rod. In addition, and in further contrast to FIGS. 7A and 7B of the IFBA-coated pellet, the presence of a high burnup structure (HBS) 825 is visible.

Based on FIGS. 7A-8B and Tables 1 and 2, it appears that the IFBA layer could impact FFRD and ballooning/bursting by delaying and/or reducing HBS formation and bonding layer properties. The outside surface of the non-IFBA pellets bond with the inner oxide surface of the zirconium cladding. Note that an extremely thin and dense oxide layer forms almost instantaneously on zirconium material as it is manufactured. The IFBA material or the products of the reacted IFBA layer appear to prevent the formation of the UO₂—ZrO₂ bond. Once moderate burnup is achieved in non-IFBA rods (about 30-40 MWd/kgU), the fuel and clad are in physical contact, causing an intimate chemical interaction, including limited interdiffusion, between UO₂ and ZrO₂. This chemical bonding restricts axial gas communication and limits the flow of gas from the rod to the plenum, allowing a local build up pressure during LOCA transients, which, when coupled with local transient fission gas release, in turn contributes to local balloon and burst.

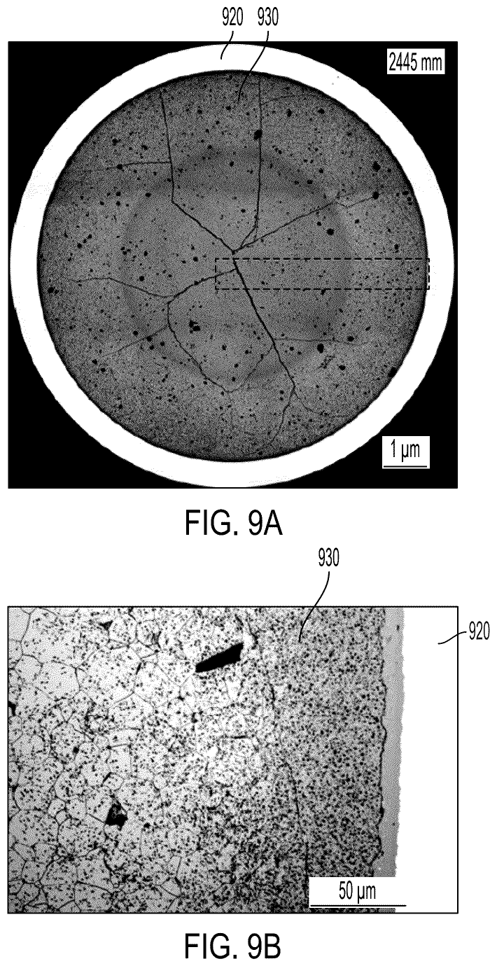

Further, FIGS. 9A and 9B show typical cross sections of a non-IFBA fuel rod. In this particular case, the cross section is taken 2445 mm above the bottom of the rod. The white bar in the lower right of FIG. 9A represents 1 mm in length. The white bar in the lower right of FIG. 9B represents 50 μm. Both FIGS. 9A and 9B show a full fuel-clad bond at the boundary between the fuel 930 and the cladding 920.

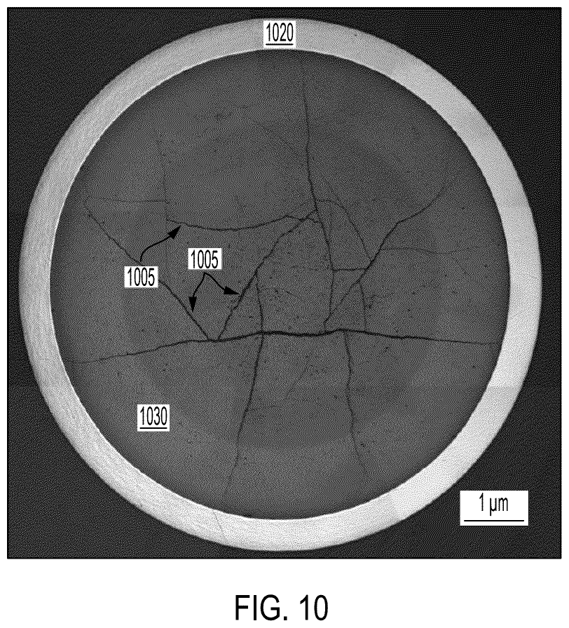

FIG. 10 is a photograph of a cross-sectional cut of sample VCS1, previously presented as the IFBA fuel rod in the fission gas release tests. The cut was made 2984 mm from the bottom end of the fuel rod and the surface has been polished. The fuel pellet 1030 is contained in the cladding 1020. Cracks 1005 can be seen in the fuel pellet 1030. The white bar in the lower left of the figure represents 1 mm in length. The local burnup for this specimen is about 83 MWd/kgU, and remarkably, the fuel-clad gap has survived to this burnup, where for non-IFBA fuels it may have been expected to have closed by only 30-40 MWd/kgU. This supports strongly the assertions presented above in reference to FIGS. 7A-8B.

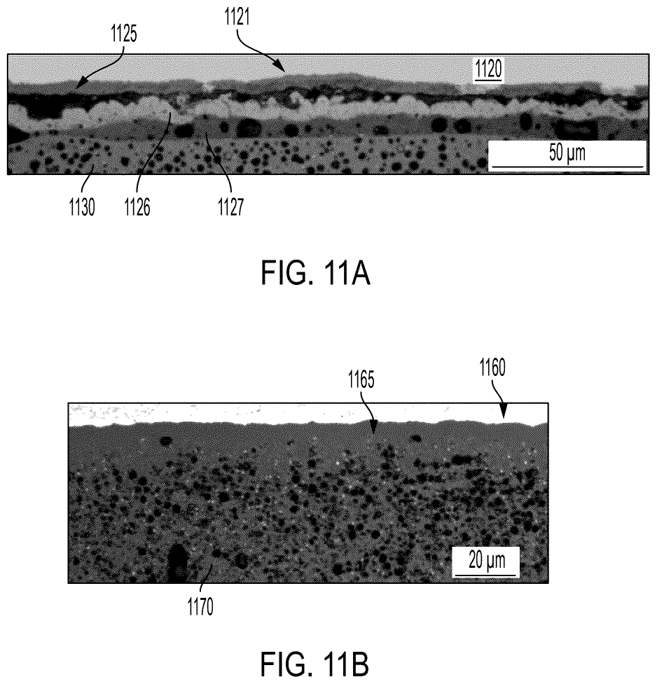

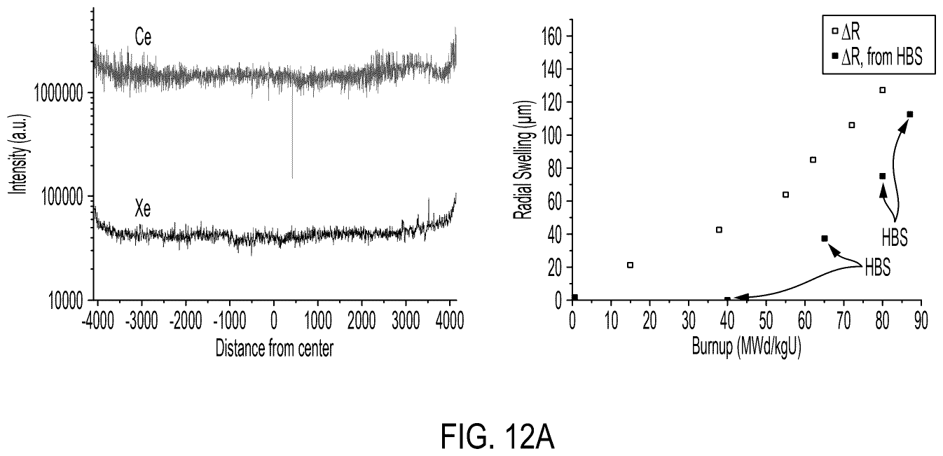

The IFBA-coated fuel pellet 1030 in fuel rod VCS1 leads to a different cladding inside than the non-IFBA pellets in fuel rods VCS2-VCS6. FIG. 11A is an enlarged portion of the photograph in FIG. 10 showing the cladding/fuel pellet interface at 0° orientation. The bar in the lower right of the figure represents 50 μm. FIG. 11A demonstrates that there are four layers between the cladding 1120 and the pellet 1130:
1) an inner cladding oxide 1121, about 5 μm thick,
2) a gap 1125,
3) a wavy, whitish layer 1126 with some minor porosity, and
4) a grey layer 1127 close to the fuel pellet surface containing large pores.

FIG. 11B is a detailed photograph of the cladding/fuel pellet interface of fuel rod VCS2 at a cut taken 2884 mm above the bottom of the fuel rod with an orientation of 180°. Note that FIGS. 11A and 11B are presented at the same scale. VCS2 is similar to VCS1 in burnup (greater than 70 MWd/kgU) and irradiation history except that VCS2 does not have IFBA. The bar at the lower right of the figure represents 20 μm. The cladding 1160 and the fuel pellets 1170 are completely bonded. The fuel-clad interaction layer 1165 has the characteristic wavy appearance between the zirconium alloy of the cladding 1160 and the porous uranium oxide of the pellet 1170 and contains all three of uranium, plutonium, and zirconium in oxide form.

The results of the Studsvik test data presented above lead to a surprising, unexpected, and very useful insight. That is, the IFBA coatings can be useful not only to control the early burnup in fuel rods but can also be useful in preventing or mitigating ballooning and bursting of cladding during LOCA and the subsequent fuel fragmentation, relocation, and dispersal (FFRD).

There appears to be two effects of IFBA coating that either alone or in combination contribute to preventing or mitigating ballooning and/or bursting of cladding and FFRD (herein, BBF) as a result of LOCA. Drivers of BBF in a LOCA include temperature, pressure, and burst.

During a LOCA, the loss of the ability to cool causes an increase in temperature, which produces an increase in cladding plasticity and high temperature creep due to increasing pressure inside the cladding. The temperature increase also drives transient fission gas release (tFGR). TFGR is fission gas that is normally stored in the fuel but is released in a relatively short amount of time because of a sudden change in reactor conditions. The tFGR increases the pressure inside the cladding. All of these serve to reduce the mechanical integrity of the cladding. When fuel-cladding bonding occurs, axial gas communication is strangled. Thus tFGR generated in one part of a core, say, a hotter portion of the core, cannot be distributed throughout the core, reducing the local pressure. Instead, local tFGR causes a local pressure increase and enhances local ballooning. When the cladding bursts, the rapid depressurization contributes to fine fragmentation (along with underlying microstructural predisposition). The United States Nuclear Regulatory Commission (NRC) considers FFRD a leading factor that is limiting the full exploitation of fuel up to high burnouts (greater than 68 MWd/kgU) as FFRD has been observed to start at around 60 MWd/kgU.

High burnup structure (HBS) forms in the fuel rim (that is, the fuel pellet rim) due to accumulation of fission products (FP) and defects. HBS features high porosity and high local fission gas (FG) storage. HBS stores two to three times more FG per volume than the inner pellet structure, and, for geometrical reasons, given the rim represents a larger fraction of the total fuel cross section relative to interior portions of the fuel, the FG inventory of the high burnup rim can represent over 20% of the total fuel fission gas. HBS also has a low thermal conductivity, which increases the peak centerline temperature of the fuel. Not only that, but the rim having low thermal conductivity increases the temperature of the fuel throughout the pellet. When heat is not transferred to the coolant effectively and efficiently because of the presence of a low thermal conductivity layer, that is, the HBS rim, then the entire pellet increases in temperature with the centerline having the highest temperature. The porosity, thickness, and fission gas inventory of the HBS grow with increasing burnup (BU). By the FFRD threshold, the HBS is responsible for about 20% of the total fuel pellet swelling and that fraction continues to rise to about one-third by 75 MWd/kgU burnup.

The concentration of defects in the fuel pellet is equal to the difference between the production of defects and the destruction of defects:

$${C}_{defects} = Production - Destruction .$$

Production of defects is highest in the rim due to the highest thermal neutron flux, while destruction of defects is lowest in the rim due to due to the lowest temperature (lack of annealing or elimination of defects due to recombination of the crystal structure). This simple equilibrium underlies the mechanism of HBS formation. As the defects and fission products produced in the rim have a low rate of anneal due to low temperatures, they continuously build up until the fuel microstructure itself disintegrates, forming instead a large number of sub-micron grains and large fission gas bubbles, ultimately giving rise to the deleterious thermomechanical properties of the HBS which have been previously described.

Modification of HBS can result from decreasing the production of defects or from increasing the destruction of defects. The latter involves thermal annealing and is non-physical because of fundamental PCT and thermohydraulic constraints, which place requirements on the coolant temperature. Without being able to allow the coolant temperature to be varied to impact annealing of defects, the destruction of defects does not appear to be a viable way to lower the concentration of defects. The former, decreasing defect production, may be accomplished by reducing neutron flux at the rim through a burnable absorber (BA) coating.

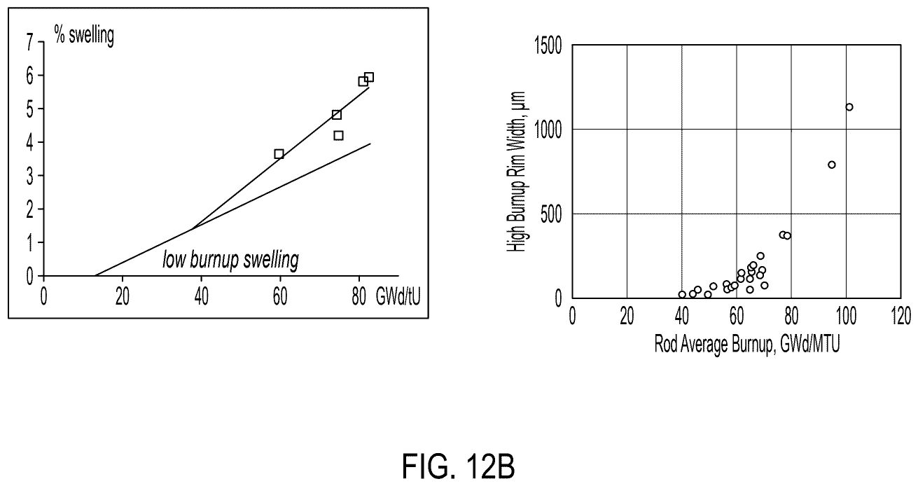

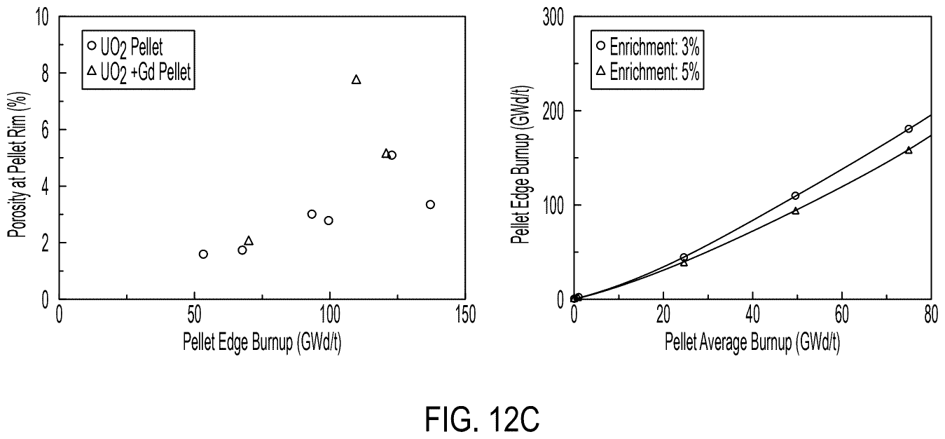

FIGS. 12A-12C present a series of plots that demonstrate effects of an HBS on the properties of a fuel pellet without IFBA coating. In the left of FIG. 12A, the intensity of xenon (Xe, bottom) and cerium (Ce, top) is plotted in arbitrary units as a function of distance from the center of the fuel pellet. Notable is the increase in both Xe and Ce at the outer edges of the fuel pellet. As burnup of the fuel increases, the amount of porosity increases and as the thickness of the HBS increases, the fission gas inventory also increases.

Moving to the right of FIG. 12A, the radial swelling, in μm, of a fuel pellet is shown as a function of burnup in MWd/kgU. The data points with a larger value at any given burnup represent the total radial swelling, whereas the smaller value represents the contribution to swelling from the HBS. Below 40 MWd/kgU, there is almost no contribution to swelling from the HBS, as it has not yet been formed. As the burnup increases, the fraction of swelling attributable to HBS also increases.

The plot on the left of FIG. 12B presents fuel pellet swelling, in percent, at high burnup as a function of burnup in gigawatt-days (GWd) per metric ton (1000 kg) of uranium (tU). The line with the smaller slope represents low burnup swelling. Beginning at 40 GWd/tU, the slope increases as HBS begins to contribute to the swelling.

The plot on the right of FIG. 12B presents high burnup rim width, in μm, as a function of fuel rod average burnup, in GWd/MTU, where MTU is metric tons of uranium. Again, the trend of accelerating rate increase in width occurs with increasing burnup.

The plot on the left of FIG. 12C looks at porosity at the pellet rim as a function of pellet edge burnup for both uranium dioxide pellets with and without gadolinium (Gd) which also can serve as an IFBA material though the gadolinium is dispersed throughout the pellet rather than just at the outer rim of the pellet. Gadolinium has a large thermal neutron cross section, the largest of any element. But it has no effect on the porosity of the rim region.

The right plot of FIG. 12C compares fuel pellet edge burnup as a function of fuel pellet average burnup. Both axes are displayed in units of GWd/t. Pellets with uranium-235 enrichments of 3% and 5% are compared. The three-percent enriched sample shows more edge burnup for the same amount of pellet average burnup compared to the five-percent enriched sample. Note that for every data point, the edge burnup is approximately twice as large as the pellet average.

IFBA affects HBS in the following ways. IFBA includes high concentrations of ¹⁰B deposited on a surface, for example, the surface of fuel pellets. As the ¹⁰B interacts with the thermal neutrons coming from outside of the fuel rod with a (n, α) reaction, IFBA reduces the production of fission products, though almost only at the rim of the fuel through hardening of the neutron spectrum and forces a relatively larger fraction of fission reactions to occur deeper within the pellet. Further, IFBA outcompetes fission and plutonium production (via absorption of neutrons by uranium-238) at the rim. IFBA, as a burnable absorber, presently burns out at about 15-20 MWd/kgU. It is estimated that this burn out of the IFBA may delay HBS onset by up to 15 MWd/kgU. Where non-IFBA fuel may experience HBS at about 40 MWd/kgU, IFBA-coated fuel may not experience HBS until 50-55 MWd/kgU. IFBA is also expected to result in lower fission gas stored in the rim for a given burnup, ceteris paribus. Further, IFBA is expected to result in lower porosity (and associated swelling) at the rim. Studsvik post-irradiation examination (PIE) confirmed a gap between cladding and IFBA-coated pellet still existed at even 83 MWd/kgU local burnup. In contrast, non-IFBA samples showed no gap remaining at only 40-50 MWd/kgU, depending somewhat on irradiation history. This evidence points toward a larger gap and lower tFGR inventory with IFBA as an explanation for reduced driving force for ballooning and bursting observed at Studsvik.

Thus, IFBA can be optimized and tailored to achieve additional advantageous effects regarding suppression of HBS and eliminating or mitigating ballooning and bursting of cladding from LOCA and the related fuel fragmentation, relocation, and dispersal. IFBA+, an optimized IFBA can flatten out the typical radial burnup profile, shifting fission preferentially from the rim to the center of the fuel pellet to the extent desired by end-of-life design basis. For example, an optimized design may target HBS suppression up to about 20 MWd/kgU burnup below the targeted discharge burnup, giving that rod the characteristics of a non-IFBA fuel rod irradiated up to 60 MWd/kgU. In another example, the burnout point could be approximated as (Target burnup−BA burnout)=40 MWd/kgU, or such that the rim burnup does not exceed approximately 100-120 MWd/kgU, the onset burnup of the high burnup structure.

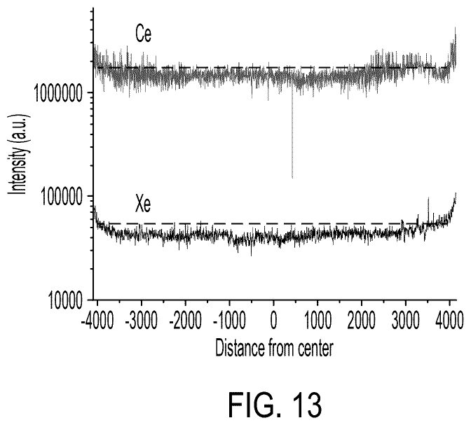

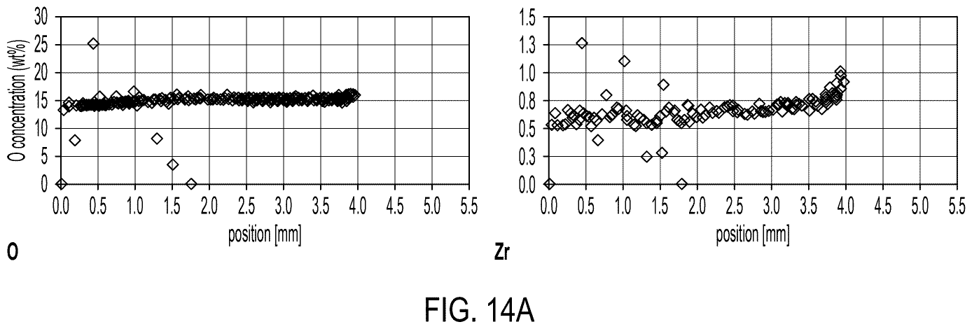

Referring now to FIG. 13, one sees the same data plotted in the lefthand plot of FIG. 12A. FIG. 13 adds a dashed line for both the xenon data and the cerium data. These dashed lines represent an improved, flattened out profile mentioned above, which may be an ideal distribution of cerium and xenon. The dashed lines represent a uniform distribution of each element across the fuel pellet with no edge effects due to high burnup structure.

IFBA+ can be tuned by burnable absorber (BA) thickness and enrichment of BA material in absorbing isotopes such as higher 10B enrichments of using absorbers with low to moderate thermal neutron absorbers such as Sm or Hf and the like.

Further, IFBA+ may convert fuel performance of HBU to “younger” fuel by several burnup decades. This improvement may be a key enabler for high energy fuel (HEF) and HBU fuel programs by delaying the onset of FFRD and pellet thermal conductivity degradation (TCD) to much higher burnups.

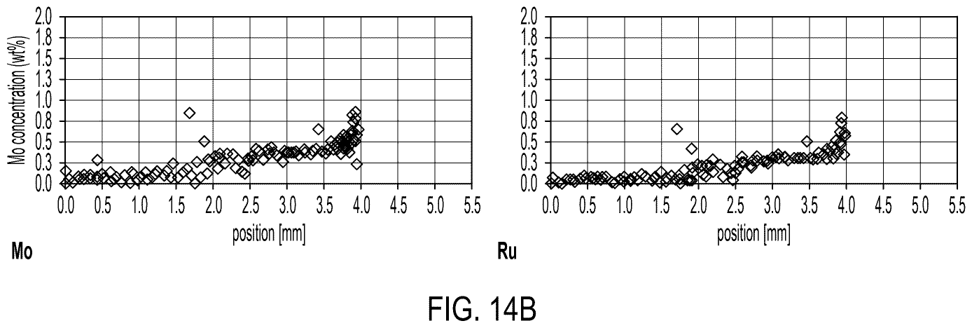

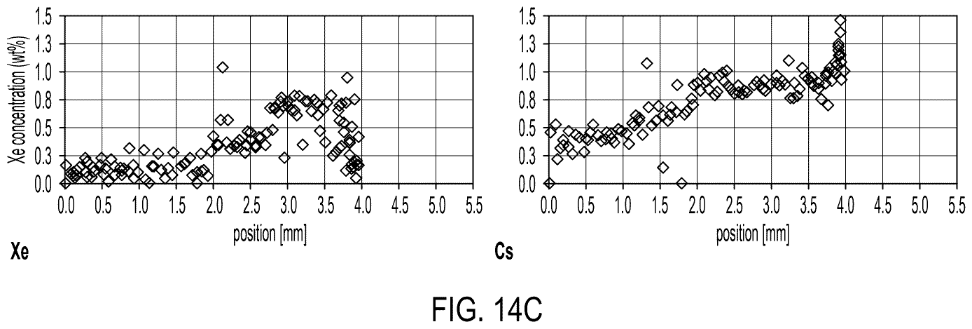

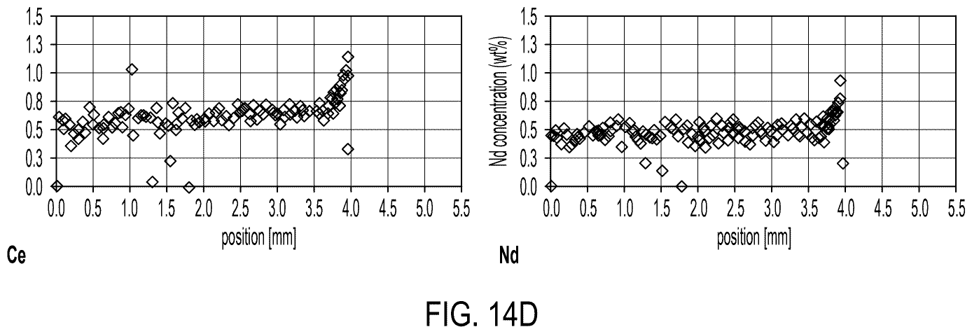

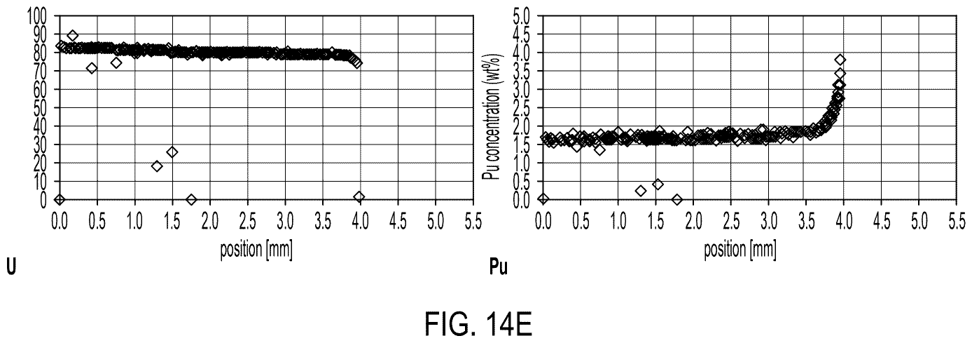

FIGS. 14A-14E present existing IFBA chemical analysis data from the Braidwood R05 fuel rod at a height of 2700 mm from the bottom of the rod. The local burnup is 60 MWd/kgU. Each graph presents the concentration of an element in weight percent (wt. %) as a function of position in mm away from the centerline of the fuel pellet. FIG. 14A presents oxygen (O) and zirconium (Zr). FIG. 14B presents molybdenum (Mo) and ruthenium (Ru). FIG. 14C presents xenon (Xe) and cesium (Cs). FIG. 14D presents cerium (Ce) and neodymium (Nd). FIG. 14E presents uranium (U) and plutonium (Pu). With two exceptions, all the elements show an increased concentration at the rim (near 4.0 mm). Plutonium has increased significantly at the edge, which is in keeping with the higher burnup at the edge. Oxygen remains essentially flat (constant) across the pellet. Uranium concentration drops toward the pellet edge, another indication of burnup occurring more strongly at the pellet rim than in the interior.

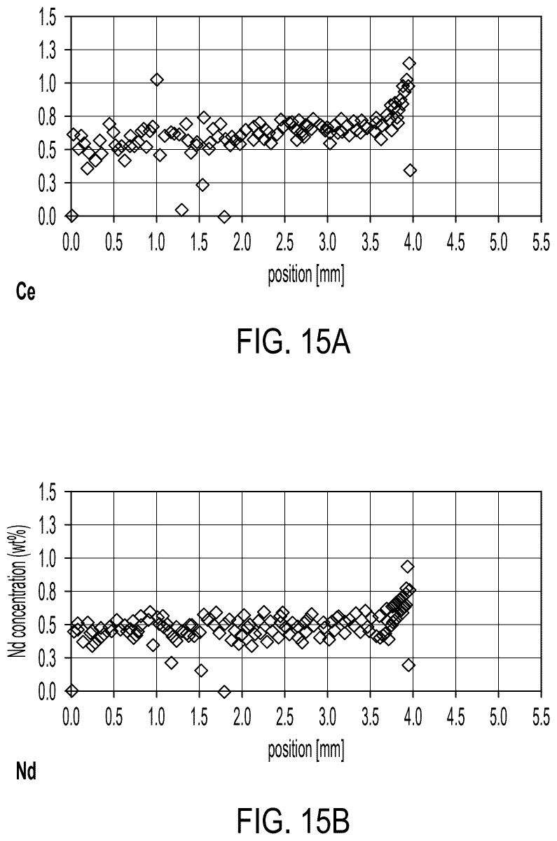

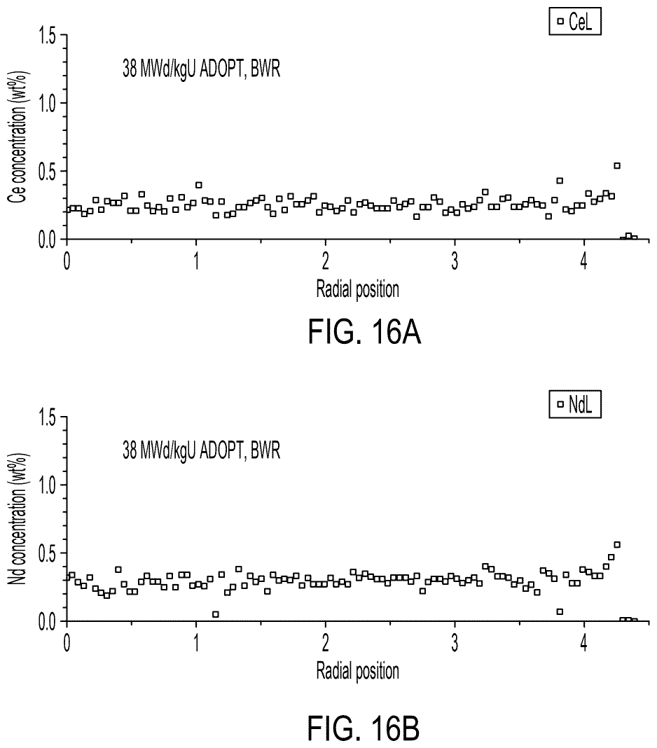

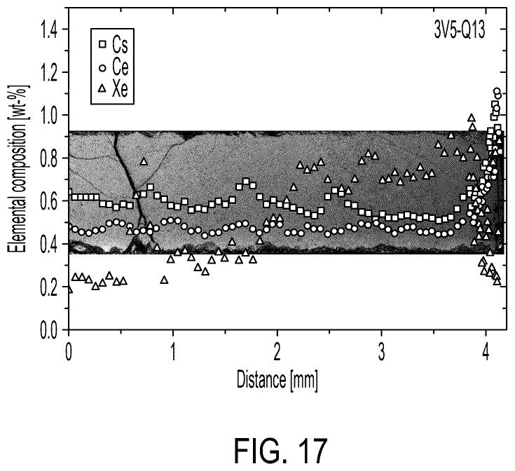

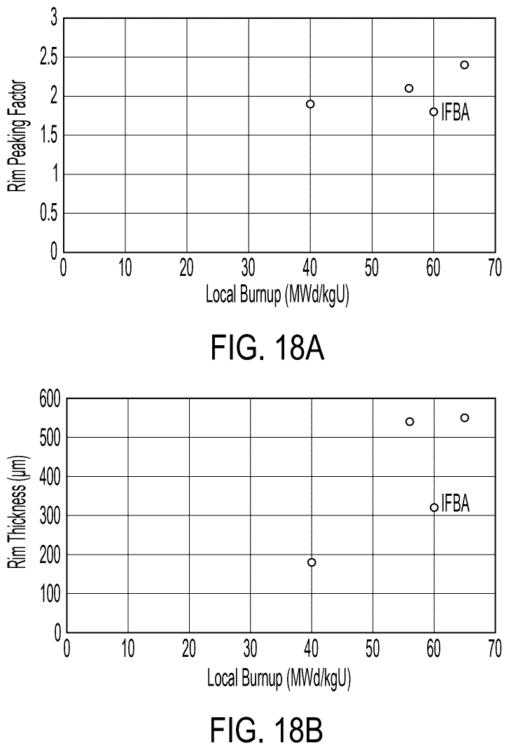

Referring now to FIGS. 15A-17, a comparison is presented between IFBA (FIGS. 15A and 15B), ADOPT™ (Advanced Doped Pellet Technology) (FIGS. 16A and 16B), and a standard UO₂ rod (FIG. 17). The IFBA fuel rod is the Braidwood R05 fuel rod discussed above. The ADOPT™ fuel rod is Fosmark 2 H8 from a boiling water reactor (BWR). The burnup of the ADOPT™ rod is 38 MWd/kgU (local), only about two-thirds that of the IFBA rod. The rim thickness of the of the IFBA rod is 320 μm, the ADOPT™ rim thickness is 180 μm, and the Ringhals standard UO₂ is 550 μm. The standard UO₂ rod is Ringhals 3V5-Q13 from a pressurized water reactor (PWR). The burnup of the standard UO₂ rod is 65 MWd/kgU (local).

To get a sense of the HBU effect at the rim compared to the rest of the pellet, the data presented in these figures can be analyzed to provide a peak-to-average ratio. For the IFBA, the ratio is 1.8. For the ADOPT™ sample, the ratio is 1.9. For the standard UO₂, the ratio is 2.4. FIGS. 15A and 16A present cerium (Ce) concentration in weight percent as a function of radial position. FIGS. 15B and 16B do the same for neodymium (Nd). FIG. 17 presents similar data for cesium (Cs), cerium (Ce), and xenon (Xe).

Table 4 below summarized the comparison of the IFBA, the ADOPT™, and the two standard UO₂ rods. The rim thickness measurement was made using only chemical data. Ceramographic investigation of rim thickness is preferred, but not yet available. The rim thickness and the rim peaking factor should increase with increasing burnup. However, as seen in FIGS. 20A and 20B, the IFBA sample clearly does not fit the expected trend.

TABLE 4
Comparison of IFBA to ADOPT and Standard UO2

| | | | | Rim | |
|---|---|---|---|---|---|
| | | | Local | Thickness | Rim |
| | Fuel | Reactor | Burnup | (from Ce, | Peaking |
| Rod | Type | Type | (MWd/kgU) | μm) | Factor |
| F2B10 | ADOPT | BWR | 40 | 180 | 1.9 |
| R05 | IFBA | PWR | 60 | 320 | 1.8 |
| Q13 | UO2 | PWR | 65 | 550 | 2.4 |

Another factor contributing to the success of IFBA-coated pellets reducing or eliminating ballooning, bursting, and associated FFRP may be that ZrB₂ bonds differently to cladding chemically relative to UO₂, decreasing the strength of the bond. These differences were noted above in reference to FIGS. 11A and 11B.

IFBA+ coating may be on surface of fuel pellet, the inner surface of the cladding, the outer surface of the cladding, or any combination thereof.

One or more embodiments include a uranium oxide fuel form having an inner region and an outer rim region. For instance, the fuel form can be cylindrical, and the inner region and outer rim region can be coaxial regions within the same cylinder. The outer rim is composed of a coating of an absorber material which possesses a total thermal neutron interaction cross section in excess of the U-238 capture cross section. This causes preferential absorption of thermal neutrons by the outer region rather than capture by U-238. The thickness of this layer and the choice of absorber which can utilize compounds containing B, Sm, Hf, Gd, Eu, Dy, Yb or Er, may be optimized to ensure optimal suppression of the high burnup structure and minimal deleterious effects on fuel k-effective and cladding inner pressure. This layer also utilizes chemical compounds such as B, ZrB₂, HfB₂, SmB₄, SmB₆, that when decomposed (to lithium in the case of boron), inhibit the formation of a bond between the UO₂ and the zirconium cladding.

In one or more embodiments, a coating is applied to the inner surface of the nuclear fuel cladding with the same properties and fulfilling the same function as described above.

In one or more embodiments, the incorporation of material serving a similar function in the outer part of a uranium dioxide fuel pellet by means other than coating, such as by 3D printing or by composite manufacturing methods.

Table 5 identifies some elements that may be suitable for IFBA+. In the table, “nat” indicates natural abundance. Thermal neutron cross sections are expressed in barns (10⁻²⁴ cm²). Useful molecular forms of some candidates are listed, along with comments. Gadolinium is “black,” that is, it has a large cross section and would be, in a sense, a “black body” that would absorb a high fraction of thermal neutrons incident upon it. Further, after absorbing a neutron, gadolinium (Gd) transmutes into another product that also has a large absorption cross section. The large residual neutron absorption cross section needs to be accounted for in determining the burnup time of the burnable absorber.

Samarium (Sm) may be combined with boron as SmB₆ as shown in the table or SmB₄. Boron-10 absorbs a neutron and becomes lithium plus an alpha particle (that is, a helium nucleus) and contributes to fuel rod internal pressure by generating helium gas. Europium (Eu) and hafnium (Hf) may also be used as a boride for creating a burnable absorber.

TABLE 5
IFBA+ Candidates and Criteria

| Element | σ natural thermal neutron | |
|---|---|---|
| (mass number of isotope(s) | cross section | |
| with largest thermal | (largest cross section) | |
| neutron cross section) | 1 × 10⁻²⁴ cm² | |
| Gd nat | 49,000 | (61,000/250,000) |
| (155/157) | | |
| Sm nat | 5,600 | (40,140) |
| (149) | | |
| B nat | 760 | (3,800) |
| (10) | | |
| Cd nat | 2,500 | (20,600) |
| (113) | | |
| Eu nat | 4,500 | (9,200) |
| (151) | | |
| Dy nat | 943 | (2,650) |
| (164) | | |
| Er nat | 156 | (649) |
| (167) | | |
| Yb nat | 35 | (2,300) |
| (168) | | |
| Hf nat | 104 | (373) |

(177)

In some instances, IFBA+ includes a “gray” absorber. That is, close to black (an almost complete absorber with a large cross section) but with a somewhat small thermal neutron absorption cross section. As an example, an IFBA cross section of about 3×10²¹ atom-barns/cm². A cross section lower than IFBA would require a thicker layer (slower burnout), while a cross section higher than IFBA would require a thinner layer or feature faster burnout. It may be desirable to keep the cross section of a coating for the fuel or the classing to have a cross section similar in value to that of the IFBA cross section. Therefore, it may be desirable to have an absorption cross section not much higher than that of ¹⁰B (e.g., about 3800 barns (b)) else the BA will burn out too quickly and depress fission reactivity too much.

In addition, the BA coating or layer should not be too thick. A thick layer would displace too much uranium, and the BA coating needs to burn out as ²³⁵U decreases and fission products increase. A thickness between 0 and 500 microns may be desirable and more specifically 0 to 300 microns.

In some instances, the burnable absorber has a single high cross section isotope so that residual neutron absorption is low. That is, after a nucleus in the burnable absorber absorbs a thermal neutron, the nucleus converts to a nucleus with a low neutron absorption cross section. In that sense, the burnable absorber “burns up.”

In one or more embodiments, the burnable absorber, say, IFBA+, outcompetes fission and plutonium production by hardening the spectrum (absorbs the thermal (low energy) neutrons more efficiently than higher energy neutrons so that the neutron flux is primarily fast (higher energy) neutrons) at only the rim of the fuel pellet. Such an effect may be produced by either coating a fuel pellet or by a coating or liner to the inner wall of the cladding. Hafnium may also be substituted in the cladding to fully or partially replace the zirconium. The compound may be chemically stable, inert to UO₂ (the fuel) and zirconium cladding (or some other type of cladding).

While boron is used in IFBA, boron has the drawback of producing helium, which contributes to higher rod internal pressure. This increase in pressure may be contrary to the desire to avoid ballooning and bursting of the cladding in a LOCA.

In one or more embodiments, a fuel rod includes a boron-free coating disposed on at least one surface of a fuel rod. Specifically, the boron-free coating is applied to one or more of the outer surface of the fuel pellets, the outer surface of the cladding, and/or the inner surface of the cladding.

In one or more embodiments, a nuclear fuel rod with high burnup suppression includes a cladding with fuel pellets arranged inside the cladding. Each pellet includes fissile material such as uranium dioxide or other suitable fissile material. The fuel rod also includes a first layer that includes a burnable absorber disposed on at least one of an outer surface of each fuel pellet, an inner surface of the cladding, or an outer surface of the cladding, the burnable absorber deposited on the pellet burning out after about 20 MWd/kgU or more of fuel burnup, the burnable absorber deposited on the cladding burning out after about 15 MWd/kgU or more of fuel burnup. In one or more embodiments, the burnout exceeds 20, 30, 40, 50, 80, or 100 MWd/kgU, depending on the design parameters of the reactor and the type of fuel, fuel enrichment, and the like.

In one or more embodiments, the nuclear fuel rod described above includes the first layer suppressing the formation of a high-burnup rim structure by at least 10 MWd/kgU of fuel burnup. Preferably, rim structure suppression may be between 10 and 20 MWd/KgU.

In one or more embodiments, the nuclear fuel rod of described above suppresses the formation of a high-burnup rim structure until at least 50 MWd/kgU of fuel burnup. Preferably, rim structure formation may occur between 60 and 80 MWd/kgU.

In one or more embodiments, the burnable absorber of the nuclear fuel rod disclosed above includes at least one of boron, gadolinium, europium, dysprosium, samarium, cadmium, iridium, hafnium, ytterbium, erbium, or an oxide, nitride, carbide, or boride thereof.

In one or more embodiments, the first layer of nuclear fuel rod disclosed above coats the outer surface of each fuel pellet.

In one or more embodiments of the nuclear fuel rod disclosed above, there is no second layer that includes fissile material between the first layer and the fissile material.

In one or more embodiments, the nuclear fuel rod of disclosed above has no second layer between the first layer and the fissile material.

In one or more embodiments, the fissile material of the nuclear fuel rod of disclosed above includes at least one of uranium-233 dioxide, uranium-235 dioxide, plutonium-239 dioxide, or mixed oxide (MOX).

In one or more embodiments, the first layer prevents, or resists, a chemical bond between the cladding and the fuel pellet.

In one or more embodiments, the first layer of the nuclear fuel rod disclosed above, coats the inner surface of the cladding.

In one or more embodiments, the nuclear fuel rod disclosed above has a composition of and a radial thickness of the first layer that reduces a rim peak-to-average radial chemical profile of each fuel pellet to below a determined threshold at a determined burnup. The rim peak-to-average ratio may preferably be between 1 and 2, inclusive, though values outside this range may be used as well. In one or more embodiments, the rim burnup is preferably kept below 80-100 MWd/kgU, the approximate burnup at which the high burnup structure (HBS) begins to form.

In one or more embodiments, a plurality of fuel pellets of the nuclear fuel rod disclosed above comprises uranium dioxide and the total thermal neutron interaction cross section of the burnable absorber exceeds the U-238 thermal neutron capture cross section. Some fuels, such as boiling water reactor (BWR) fuel may not have the same pellet composition or IFBA composition throughout the whole fuel rod.

In one or more embodiments, the first layer of the nuclear fuel rod disclosed above comprises one or more chemical compounds that after undergoing neutron-induced transformation into a new species, element, or compound, or undergoing a chemical reaction or otherwise decomposing inhibit formation of a bond between the uranium dioxide and the cladding.

In one or more embodiments, the chemical compounds include at least one of B, ZrB2, HfB2, SmB4, or SmB6, or carbides or oxides of B, Hf or Sm.

In one or more embodiments, the nuclear fuel rod disclosed above has a concentration of the burnable absorber in the first layer and/or a thickness of the first layer that suppresses a difference between a concentration of a fission product at a radial edge of the fissile material and a concentration of the fission product at a center of the fissile material to a determined level at a determined burnup.

In one or more embodiments, the nuclear fuel rod disclosed above produces at least one of the following as a fission product: cerium, neodymium, cesium, xenon, oxygen, zirconium, molybdenum, or ruthenium.

In one or more aspects, a coating on a surface of a fuel rod includes a burnable absorber that burns out after about 20 MWd/kgU or more fuel burnup.

In one or more aspects, a method for suppression of high burnup includes applying a coating to a surface of a fuel rod, where the coating includes at least one of boron, gadolinium, europium, dysprosium, samarium, cadmium, iridium, hafnium, ytterbium, erbium, or an oxide, nitride, carbide, or boride thereof, and suppressing, by the coating, formation of a high-burnup rim structure in the fuel rod until after at least 50 MWd/kgU of fuel burnup.

In one or more embodiments, the method disclosed above, applying the coating includes at least one of three-dimensional (3D) printing (additive manufacturing), and composite manufacturing among others.

In one or more aspects, a method for reducing cladding-fuel bonding includes applying a coating to an outer surface of a fuel pellet comprising uranium dioxide or an inner surface of cladding, where the coating includes at least one or more chemical compounds that after undergoing neutron-induced transformation into a new species, element, or compound, or undergoing a chemical reaction or otherwise decomposing inhibit formation of a bond between the uranium dioxide and the cladding.

One or more components may be described as “configured to,” “configurable to,” “operable/operative to,” “adapted/adaptable to,” or similar terms. Unless explicitly stated, these terms encompass components in both active and inactive states.

Unless stated otherwise, terms like “including” or “having” should be interpreted as open-ended (i.e., “including but not limited to”). Numeric claim recitations generally mean “at least” the stated number, and disjunctive terms like “A or B” should be interpreted to include either or both unless explicitly specified. Operations in any claim may generally be performed in any order unless explicitly stated. The recitation “at least one of A, B, and C” should be interpreted as any combination of A, B, and C, such as A alone, B alone, C alone, A and B together, A and C together, B and C together, and/or A, B, and C together. The recitation “at least one of A, B, or C” should be interpreted to include A alone, B alone, C alone, A and B together, A and C together, B and C together, and/or A, B, and C together.

The term “substantially”, “about”, or “approximately” as used in the present disclosure, unless otherwise specified, means an acceptable error for a particular value as determined by one of ordinary skill in the art, which depends in part on how the value is measured or determined. In certain embodiments, the term “substantially”, “about”, or “approximately” means within 1, 2, 3, or 4 standard deviations. In certain embodiments, the term “substantially”, “about”, or “approximately” means within 50%, 20%, 15%, 10%, 9%, 8%, 7%, 6%, 5%, 4%, 3%, 2%, 1%, 0.5%, or 0.05% of a given value or range.

In summary, various embodiments have been described to illustrate the principles and applications of the disclosed systems and methods. These descriptions are not intended to limit the scope of the claimed subject matter, and variations may be made by those skilled in the art. The accompanying claims define the broadest legal scope of this disclosure.

What is claimed is:

1. A nuclear fuel rod with high burnup suppression, the rod comprising:
a cladding;
a plurality of fuel pellets arranged inside the cladding, each pellet comprising fissile material; and
a first layer including a burnable absorber disposed on at least one of an outer surface of the fuel pellets, an inner surface of the cladding, or an outer surface of the cladding, the burnable absorber disposed on the pellet burning out after about 20 MWd/kgU or more of fuel burnup, the burnable absorber disposed on the cladding burning out after about 15 MWd/kgU or more of fuel burnup.

2. The nuclear fuel rod of claim 1, wherein the first layer is to suppress formation of a high-burnup rim structure by at least 10 MWd/kgU of fuel burnup.

3. The nuclear fuel rod of claim 1, wherein formation of a high-burnup rim structure is suppressed until at least 50 MWd/kgU of fuel burnup.

4. The nuclear fuel rod of claim 1, wherein the burnable absorber includes at least one of boron, gadolinium, europium, dysprosium, samarium, cadmium, iridium, hafnium, ytterbium, erbium, or an oxide, nitride, carbide, or boride thereof.

5. The nuclear fuel rod of claim 1, wherein the first layer is coating the outer surface of a plurality of the pellets.

6. The nuclear fuel rod of claim 5, wherein no second layer that includes fissile material exists between the first layer and the fissile material.

7. The nuclear fuel rod of claim 6, wherein no second layer exists between the first layer and the fissile material.

8. The nuclear fuel rod of claim 1, wherein the fissile material includes at least one of uranium-233 dioxide, uranium-235 dioxide, plutonium-239 dioxide, mixed oxide (MOX), or nitrides, carbides, borides, or metals of the same.

9. The nuclear fuel rod of claim 1, wherein the first layer prevents a chemical bond between the cladding and the fuel pellet.

10. The nuclear fuel rod of claim 1, wherein the first layer of material coats the inner surface of the cladding.

11. The nuclear fuel rod of claim 1, wherein a composition of and a radial thickness of the first layer reduces a rim peak-to-average radial chemical profile of each fuel pellet to below a determined threshold at a determined burnup.

12. The nuclear fuel rod of claim 1, wherein each fuel pellet comprises uranium dioxide and a total thermal neutron interaction cross section of the burnable absorber exceeds a U-238 thermal neutron capture cross section.

13. The nuclear fuel rod of claim 12, wherein the first layer comprises one or more chemical compounds that after undergoing neutron-induced transformation into a new species, element, or compound, or undergoing a chemical reaction or otherwise decomposing inhibit formation of a bond between the uranium dioxide and the cladding.

14. The nuclear fuel rod of claim 13, wherein the one or more chemical compounds includes at least one of B, ZrB₂, HfB₂, SmB₄, or SmB₆.

15. The nuclear fuel rod of claim 1, wherein a concentration of the burnable absorber in the first layer and/or a thickness of the first layer suppresses a difference between a concentration of a fission product at a radial edge of the fissile material and a concentration of the fission product at a center of the fissile material to a determined level at a determined burnup.

16. The nuclear fuel rod of claim 15, wherein the fission product is at least one of cerium, neodymium, cesium, xenon, krypton oxygen, zirconium, molybdenum, or ruthenium.

17. The nuclear fuel rod of claim 1, wherein the first layer is boron-free.

18. A coating on a surface of a fuel rod, the coating comprising:
a burnable absorber that burns out after about 20 MWd/kgU or more of fuel burnup.

19. A method for suppression of high burnup, the method comprising:
applying a coating to a surface of a fuel rod,
wherein the coating comprises at least one of boron, gadolinium, europium, dysprosium, samarium, cadmium, iridium, hafnium, ytterbium, erbium, or an oxide, nitride, carbide, or boride thereof; and
suppressing, by the coating, formation of a high-burnup rim structure in the fuel rod until at least 50 MWd/kgU of fuel burnup.

20. The method of claim 19, wherein applying the coating comprises at least one of three-dimensional (3D) printing, composite manufacturing, plasma deposition, dipping, painting, high temperature hot spray, cold spray, chemical vapor deposition, physical vapor deposition, or ion implantation.

21. A method for reducing cladding-fuel bonding, the method comprising:
applying a coating to an outer surface of a fuel pellet comprising uranium dioxide or an inner surface of cladding,
wherein the coating includes at least one or more chemical compounds that after undergoing neutron-induced transformation into a new species, element, or compound, or undergoing a chemical reaction or otherwise decomposing inhibit formation of a bond between the uranium dioxide and the cladding.
